(19) United States
(12) Patent Application Publication
(10) Pub. No.: US 2007/0270546 A1
(43) Pub. Date: Nov. 22, 2007

(54) Polymeric compositions and films formed therefrom

(75) Inventors: Huan Yang, Katy, TX (US); Jeffrey George Southwick, Houston, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: Kraton Polymers U.S. LLC, Houston, TX (US)

(21) Appl. No.: 11/788,812

(22) Filed: Apr. 20, 2007

Related U.S. Application Data
(60) Provisional application No. 60/794,392, filed on Apr. 24, 2006.

(51) Int. Cl. C08L 53/00

(52) U.S. Cl. 525/88

(57) ABSTRACT

A polymeric composition which includes a styrene polymer, at least one unsaturated block copolymer having a high monoalkenyl arene content, a modulus less than 100,000 psi, and comprising at least one A block and at least one B block, each A block independently selected from mono alkenyl arene polymer blocks and each B block independently selected from polymer blocks having at least one conjugated diene and at least one mono alkenyl arene and having a controlled distribution. A second polymeric composition which includes a styrene polymer, at least one unsaturated block copolymer as defined hereinbefore; and at least one additional unsaturated block copolymer having a moderate monoalkenyl arene content. The polymeric composition can be used to produce films that have improved impact resistance that can be thermoformed.

### CROSS REFERENCE TO RELATED APPLICATIONS

The present application claims the benefit of U.S. Provisional Patent Application Ser. No. 60/794,392, filed Apr. 24, 2006, entitled Polymeric Compositions and Films Formed Therefrom.

### FIELD OF THE INVENTION

The present invention is directed to polymeric compositions having improved impact strength and clarity, said compositions comprising a blend of at least one styrene polymer and at least one unsaturated block copolymer. The polymeric compositions of the present invention can be used to produce films.

### BACKGROUND OF THE INVENTION

Polystyrene and other styrene polymers are commonly employed in applications requiring a high degree of clarity to permit full display of a packaged material. Although polystyrene and other styrene polymers provide excellent clarity characteristics, these polymers suffer from one glaring weakness which limits their usefulness in applications with which they would be otherwise ideally suited. That is, the brittleness of polystyrene and other styrene polymers limits their utility in many important applications. Unfortunately, there are few packaging applications, for example, wherein good impact strength does not play a significant role.

This is not to say that efforts have not been made to provide blends of polystyrene and other styrene polymers with impact modifiers to improve their impact strength. Unfortunately, those impact modifier-containing styrene polymers, although significantly improving impact strength, are often not effective insofar as the addition of an impact modifier seriously compromises the physical property most attractive in styrene polymers, clarity. That is, impact modifiers of the prior art, although increasing impact strength of styrene polymers absent the modifier, also significantly decrease clarity.

This state of affairs has existed for a long time thereby emphasizing the strong need in the art for a new impact modifier which, when added to polystyrene and other styrene polymers improves impact strength, without significantly compromising the excellent clarity possessed by such polymers.

### SUMMARY OF THE INVENTION

A new impact modifier has been discovered which, when blended with a styrene polymer at a specific ratio, produces a polymeric blend that retains the excellent clarity characteristics of an unmodified styrene polymer while also significantly increasing impact strength. In one embodiment of the present invention, a polymeric composition has been developed which includes (1) a styrene polymer blended with (2) an unsaturated block copolymer having a high monoalkenyl arene content and a modulus less than 100,000 psi. In another embodiment of the present invention, a polymeric composition is provided which includes (1) a styrene polymer blended with (2) an unsaturated block copolymer having a high monoalkenyl arene content and a modulus less than 100,000 psi and (3) an additional unsaturated block copolymer having a moderate monoalkenyl arene content. Films can be prepared using the polymeric compositions of the present invention. These films can be thermoformed into a variety of articles.

### DETAILED DESCRIPTION OF THE INVENTION

The present invention provides polymeric compositions which include (1) at least one styrene polymer and (2) at least one unsaturated block copolymer having a monoalkenyl arene content equal to or greater than 60 weight percent, based on the total weight of the block copolymer, a modulus less than 100,000 psi and comprising at least one A block and at least one B block, each A block independently selected from mono alkenyl arene polymer blocks and each B block independently selected from polymer blocks having at least one conjugated diene and at least one mono alkenyl arene and having a controlled distribution. It has surprisingly been found that by using a blend of the styrene polymer and controlled distribution unsaturated block copolymer at specific ratios, it is possible to achieve a polymeric composition having improved impact strength and excellent clarity.

The present invention further provides a second embodiment of polymeric compositions which includes (1) at least one styrene polymer, (2) at least one unsaturated block copolymer having a monoalkenyl arene content equal to or greater than 60 weight percent, based on the total weight of the block copolymer, a modulus less than 100,000 psi and at least one A block and at least one B block, each A block independently selected from mono alkenyl arene polymer blocks and each B block independently selected from polymer blocks having at least one conjugated diene and at least one mono alkenyl arene and having a controlled distribution, and (3) at least one additional unsaturated block copolymer having a monoalkenyl arene content from about 25 weight percent to about 50 weight percent, based on the total weight of the block copolymer, and at least two C blocks and at least one D block, each C block independently selected from mono alkenyl arene polymer blocks and each D block independently selected from conjugated diene polymer blocks. In this particular embodiment, it is possible to achieve improved impact and optical properties in a polymeric composition having a higher percentage of styrene polymer when an additional unsaturated block copolymer is added along with the controlled distribution unsaturated block copolymer at certain ratios.

The polymeric compositions of the present invention are particularly suitable for preparing films that will be thermoformed into a variety of articles since these films exhibit not only high impact, but also a high degree of clarity when compared to films made out of the prior art block copolymers. As used throughout this specification with regard to the present invention, the term “high impact” refers to the ability of a film to withstand puncture and tear using standard tests which are known in the art (e.g., ASTM D 3763). Furthermore, as used throughout this specification with regard to the present invention, the terms “clarity”, “clarity properties”, “optical properties” and “clarity qualities” refer to clearness and clarity as measured by haze and light transmittance using standard tests which are known in the art (e.g., ASTM D 1003).

The styrene polymers utilized in the polymeric compositions of the present invention are styrene homopolymers and include, but are not limited to general purpose crystal styrene homopolymers, high heat styrene homopolymers and high flow styrene homopolymers. Preferred styrene polymers within the present invention include general purpose crystal styrene homopolymers such as Nova® 2500. The styrene polymers within the scope of the present invention are prepared by any conventional means utilizing bulk, solution or suspension polymerization. Examples of suitable commercially available styrene polymers which may be used to prepare the polymeric compositions of the present invention include, but are not limited to, Polystyrene 144C Q599 (MI=20, commercially available from BASF); Crystal PS EA3300 (MF=1.8, commercially available from Chevron Phillips), EA3400 (MI=9, commercially available from Chevron Phillips); MC3600 (MF=13, commercially available from Chevron Phillips); Crystal Polystyrene 517 (MF=13, commercially available from Atofina); Polystyrene 580 (MF=2.4, commercially available from Atofina); and Nova® 2,500, a polystyrene polymer commercially available from Nova Chemicals.

In addition to the styrene polymers, the polymeric compositions of the present invention include one or more unsaturated block copolymers that include what has traditionally been referred to as one or more rubber blocks and one or more glassy blocks. With regard to the first embodiment of the present invention, the block copolymers utilized broadly comprise any unsaturated block copolymers that meet the following criteria:
(1) the block copolymers have a monoalkenyl arene content equal to or greater than 60 weight percent, based on the total weight of the block copolymer;
(2) the block copolymers have a modulus less than about 100,000 psi; and
(3) the block copolymers have at least one A block and at least one B block wherein each A block is a monoalkenyl arene polymer block and wherein each B block is selected from polymer blocks having at least one conjugated diene and at least one mono alkenyl arene and having a controlled distribution.

One important aspect of the above described block copolymers to be used in the present invention is the monoalkenyl arene content. As noted hereinbefore, the monoalkenyl arene content should be equal to or greater than 60 weight percent, based on the total weight of the block copolymer. Typically the monoalkenyl arene content will range from about 60 to about 85 weight percent for the block copolymer. In alternative embodiments, the monoalkenyl arene content will range from about 70 to about 80 weight percent, preferably from about 73 to about 78 weight percent.

Another important aspect of the block copolymers described above to be utilized in the present invention is the modulus of the block copolymer. As used herein, the term “modulus” refers to flexural modulus according to ASTM D-790. This modulus refers to the ratio of stress to strain for a given polymer. The block copolymers used in the present invention will have a modulus of less than about 100,000 psi. The modulus is typically less than about 90,000 psi, preferably less than about 80,000 and in some embodiments may even be less than 75,000. Regarding a lower limit, the modulus will typically not be less than about 40,000 psi, preferably not less than about 50,000 psi.

For purposes of the block copolymers utilized in the present invention, the term “melt index” is a measure of the melt flow of the polymer according to ASTM D1238 at 200° C. and 5 kg weight. It is expressed in units of grams of polymer passing through a melt rheometer orifice in 10 minutes. Broadly, the unhydrogenated block copolymers of the present invention have a melt index from about 1 to about 40 grams/10 minutes. Preferably, the melt index will range from about 3 to about 30 grams/10 minutes, more preferably from about 5 to about 20 grams/10 minutes.

The monoalkenyl arenes utilized in the A and B blocks of the above described block copolymers may be the same or different and are independently selected from styrene, alpha-methylstyrene, para-methylstyrene, vinyl toluene, vinylnaphthalene, and para-butyl styrene or mixtures thereof. Of these, styrene is the most preferred.

The conjugated dienes of the block B blocks are independently selected from 1,3-butadiene and substituted butadienes, such as, for example, isoprene, piperylene, 2,3-dimethyl-1,3-butadiene, and 1-phenyl-1,3-butadiene, or mixtures thereof. Of these, isoprene and 1,3-butadiene are the most preferred with 1,3-butadine being the more preferred of the two.

While a wide range of molecular weights of the above described block copolymers of the present invention can be used to make films, in many instances the number average molecular weight of each A block will independently range from about 5,000 to about 200,000, preferably from about 7,500 to about 150,000, and the number average molecular weight of each B block will independently range from about 10,000 to about 100,000, preferably from about 10,000 to about 75,000, for the sequential block copolymers and from about 5,000 to about 50,000, preferable from about 5,000 to about 37,500, for the coupled block copolymers.

For purposes herein with regard to the present invention, the phrase “controlled distribution” is as defined in co-pending and commonly assigned U.S. patent application Ser. No. 10/359,981, filed Feb. 6, 2003 and entitled “NOVEL BLOCK COPOLYMERS AND METHOD FOR MAKING SAME” (now U.S. Pat. No. 7,169,848). The entire contents of the U.S. Pat. No. 7,169,848 are thus incorporated herein by reference. More specifically, the molecular structure of the controlled distribution block copolymer has the following attributes: (1) terminal regions adjacent to the mono alkenyl arene homopolymer (“A”) blocks that are rich in (i.e., having a greater than average amount of) conjugated diene units; (2) one or more regions not adjacent to the A blocks that are rich in (i.e,, having a greater than average amount of) mono alkenyl arene units; and (3) an overall structure having relatively low mono alkenyl arene, e.g., styrene, blockiness. For the purposes hereof, “rich in” is defined as greater than the average amount, preferably 5% greater than the average amount. As in the other embodiments, preferably the conjugated diene of each B block is also independently selected from isoprene and butadiene with butadiene being the most preferred and the monoalkenyl arene is as defined hereinbefore with regard to A, with styrene being the most preferred.

The above described block copolymers of the present invention may be prepared by any of the methods known in the art, including sequential polymerization and coupling using standard coupling agents. The block copolymers have at least one A block and at least one B block. Preferably, the block copolymers have at least two A blocks and at least one B block. Accordingly, the block copolymers used in the present invention may comprise any block copolymer which meets the above noted criteria for the present invention, including block copolymers that are linear sequential, as well as block copolymers that are coupled [including linear coupled (having two arms or branches) and branched coupled (having greater than two, three, four or more arms or branches) block copolymers]. When the block copolymer is linear coupled or branched coupled, the arms may be symmetrical or asymmetrical. Note that when the block copolymers are prepared by coupling, small amounts of diblock copolymer may be present depending upon the coupling agent and the coupling efficiency. Preferably when the block copolymer are prepared by coupling, the amount of diblock present will be less than about 10%, preferably less than about 8%.

While not wishing to be bound by the structure of the present block copolymers, representative structures which contain at least one A block and at least one B block and which are considered to be within the scope of the present invention, provided they meet the other criteria noted above, include, but are not limited to block copolymers of the structure: A-B, A-B-A, (A-B)ₙ, (A-B)ₙ-A, (A-B-A)n-X, or (A-B)n-X, or mixtures thereof, wherein each A block is independently a polymer block of monoalkenyl arene, each B block is independently a polymer block of monoalkenyl arene and conjugated diene, X is the residue of a coupling agent and n is from 2 to 30.

As used herein, in those instances where it is noted that the blocks are “independently” a polymer block, such polymer blocks can be the same, or they can be different.

Also contemplated within the scope of the present invention are various types of the above described block copolymers that are grafted or functionalized with various functional groups such as unsaturated monomers having one or more functional groups or their derivatives, such as carboxylic acid groups and their salts, anhydrides, esters, imide groups, amide groups, and acid chlorides. The preferred monomers to be grafted onto the block copolymers are maleic anhydride, maleic acid, fumaric acid, and their derivatives. A further description of functionalizing such block copolymers can be found in U.S. Pat. No. 4,578,429 and U.S. Pat. No. 5,506,299. In another manner, the copolymers employed in the present invention may be functionalized by grafting silicon or boron-containing compounds to the polymer as taught, for example, in U.S. Pat. No. 4,882,384. In still another manner, the block copolymers of the present invention may be contacted with an alkoxy-silane compound to form silane-modified block copolymer. In yet another manner, the block copolymers of the present invention may be functionalized by reacting at least one ethylene oxide molecule to the polymer as taught in U.S. Pat. No. 4,898,914, or by reacting the polymer with carbon dioxide as taught in U.S. Pat. No. 4,970,265. Still further, the block copolymers of the present invention may be metallated as taught in U.S. Pat. No. 5,206,300 and U.S. Pat. No. 5,276,101, wherein the polymer is contacted with an alkali metal alkyl, such as a lithium alkyl. And still further, the block copolymers of the present invention may be functionalized by grafting sulfonic groups to the polymer as taught in U.S. Pat. No. 5,516,831.

It should be noted that the above-described unsaturated block copolymers used to prepare the films of the present invention may, if desired, be readily prepared by the methods set forth above. However, since many such copolymers are commercially available, it is usually preferred to employ the commercially available polymer as this serves to reduce the number of processing steps involved in the overall process. Examples of the above block copolymers which are commercially available include, but are not limited to, Kraton® MD 6459 polymer (commercially available from Kraton Polymers LLC).

One of the most important aspects of the present invention is the ratio of the styrene polymer to unsaturated block copolymer (with regard to the first embodiment of the present invention). With regard to this embodiment of the present invention, preferably the weight percent of styrene polymer in the polymeric composition will be from greater than or equal to 5 to less than 50%, preferably from greater than or equal to 10 to less than or equal to 49, and even more preferably from greater than or equal to 15 to less than or equal to 45. Preferably the weight percent of unsaturated block copolymer in the polymeric composition will be from greater than 50 to less than or equal to 95 percent, preferably from greater than or equal to 51 to less than or equal to 90, and even more preferably from greater than or equal to 55 to less than or equal to 85 percent. In other words, the ratio of styrene polymer to high monoalkenyl arene content unsaturated block copolymer (styrene polymer: high monoalkenyl arene content unsaturated block copolymer) in the polymeric compositions will be from about 5:95 to about <50:>50, more preferably from about 10:90 to about 49:51, even more preferably from about 15:85 to about 45:55.

In a still further embodiment of the present invention, polymeric compositions are contemplated which comprise (1) the aforementioned styrene polymers, (2) the aforementioned unsaturated block copolymers; and (3) an additional unsaturated block copolymer having a monoalkenyl arene content from about 25 weight percent to about 50 weight percent, based on the total weight of the block copolymer, and having at least one mono alkenyl arene block (C) and at least one conjugated diene block (D).

The monoalkenyl arenes utilized in this additional unsaturated block copolymer of the present invention are independently selected from styrene, alpha-methylstyrene, para-methylstyrene, vinyl toluene, vinylnaphthalene, and para-butyl styrene or mixtures thereof. Of these, styrene is the most preferred.

The conjugated dienes of this additional unsaturated block copolymer are independently selected from 1,3-butadiene and substituted butadienes, such as, for example, isoprene, piperylene, 2,3-dimethyl-1,3-butadiene, and 1-phenyl-1,3-butadiene, or mixtures thereof. Of these, isoprene and 1,3-butadiene are the most preferred with 1,3-butadine being the more preferred of the two.

The monoalkenyl arene content of this additional unsaturated block copolymer can be characterized as moderate and will typically be from about 25 weight percent to about 50 weight percent, based on the total weight of the block copolymer. Preferably, the monoalkenyl arene content of this additional unsaturated block copolymer component will range from about 30 to about 45 weight percent for the block copolymer with the most preferred range being from about 35 weight percent to about 40 weight percent, based on the total weight of the block copolymer.

The additional unsaturated block copolymer of the present invention may be prepared by any of the methods known in the art, including sequential polymerization and coupling using standard coupling agents. Accordingly, the additional unsaturated block copolymers used in the present invention may comprise any unsaturated block copolymer which meets the criteria for the additional unsaturated block copolymer, including block copolymers that are linear sequential, as well as block copolymers that are coupled [including linear coupled (having two arms or branches) and branched coupled (having greater than two, three, four or more arms or branches) block copolymers]. Note that when the block copolymers are prepared by coupling, small amounts of diblock copolymer may be present depending upon the coupling agent and the coupling efficiency. Preferably when the block copolymer are prepared by coupling, the amount of diblock present will be less than about 10%, preferably less than about 8%. Preferably the additional unsaturated block copolymer is a linear sequential block copolymer.

While not wishing to be bound by the structure of the present block copolymers, representative structures which contain at least two C blocks and at least one D block and which are considered to be within the scope of the present invention, provided they meet the other criteria noted above, include, but are not limited to block copolymers of the structure: C-D-C, (C-D)ₙ, (C-D)ₙ-C, and (C-D)ₙX wherein C and D are as defined hereinbefore, n is from 1 to 20, preferably from 2 to 6, and X is the residue of a coupling agent.

While the additional block copolymer of the present polymeric compositions can have a wide range of molecular weights, in many instances the number average molecular weight of each monoalkenyl arene block will independently range from about 5,000 to about 50,000, preferably from about 7,500 to about 35,000, and even more preferably from about 9,000 to about 15,000, and the total number average molecular weight of the additional block copolymer will typically range from about 35,000 to about 250,000, preferably from about 70,000 to about 125,000, even more preferably from about 90,000 to about 120,000 when the additional block copolymer is a linear sequential or linear coupled block copolymer. The number average molecular weight of the additional block copolymer will typically range from about 45,000 to about 350,000, preferably from about 80,000 to about 250,000, even more preferably from about 90,000 to about 225,000 when the additional block copolymer is coupled and has greater than two arms or branches.

Unsaturated block copolymers such as those defined above as the additional unsaturated block copolymers are available commercially and include, but are not limited to Kraton® D-1102 polymer and Kraton® D-1155 polymer, each commercially available from Kraton Polymers LLC.

As in the first embodiment, one of the most important aspects of the present additional embodiment is the ratio of the styrene polymer to unsaturated block copolymer to additional unsaturated block copolymer. With regard to this embodiment, preferably the weight percent of styrene is from 60 to 80 percent. The weight percent of unsaturated block copolymer is from 20 to 10 percent. For the additional block copolymer, the weight percent is from 20 to 10 percent. In other words, the weight ratio of styrene polymer to high monoalkenyl arene content unsaturated block copolymer to moderate monoalkenyl arene content unsaturated block copolymer (styrene polymer: high monoalkenyl arene content unsaturated block copolymer: moderate monoalkenyl arene content unsaturated block copolymer) in the polymeric compositions will be from about 60:20:20 to about 80:10:10.

The polymeric compositions of the present invention may be modified further with the addition of other polymers, fillers, reinforcements, antioxidants, stabilizers, fire retardants, anti blocking agents, anti-foggers, pigments, slip agents, nucleating agents, nanocomposites, functionalizing agent, suntan screens, lubricants and other rubber and plastic compounding ingredients without departing from the scope of this invention. Such components are disclosed in various patents including, for example, U.S. Pat. No. 3,239,478 and U.S. Pat. No. 5,777,043, the disclosures of which are incorporated by reference. When one or more of such other components are present in the block copolymer layer of the films of the present invention, they will be present in a total amount from about 0.05 weight percent to about 2.0 weight percent based on the total weight percent of the combined components in the polymeric composition.

Preferably the polymeric compositions of the present invention will be formed into a film. Such films may be made by any of the methods know in the art for making single layered films. For example, such films can be prepared by blending the block copolymer of the present invention with the styrene polymer using techniques well known in the art to provide a film. For instance, one or more unsaturated block copolymers may be physically blended with polystyrene or polystyrene and additional block copolymers as provided herein. The block copolymer of the present invention and polystyrene can be simply dry blended without the necessity of any extraordinary measures to combine the two polymers thereby forming a compatible homogeneous film after extrusion using known film extrusions devices.

The polymeric blend of styrene polymer and block copolymer(s) can be processed into a film for thermoforming. More specifically, the film can be prepared as a blown film or alternatively, the film may be formed into a cast film by extrusion. Such films can be used for thermoforming using any of the conventional techniques available. The most common techniques include made or female drapes for shallow draw parts and plug assist forming into female molds after heating.

While films of any thickness are contemplated to be within the scope of the present invention, films of the present invention are preferably in a thickness in the range from about 1 mil to about 20 mils. More preferably, the film thickness is provided in a range from about 8 mils to about 12 mils. Still more preferably, the film is provided in a thickness range from about 9 to about 10 mils.

The following examples are given to illustrate the present invention. Because these examples are given for illustrative purposes only, the present invention should not be deemed limited thereto.

The following materials were used in the examples below:
BCP1 (Block Copolymer 1) is an unsaturated block copolymer having a modulus of about 73,000, a polystyrene content of about 75% by weight, and a melt flow index of 11 g/10 min@200° C./5 kg, commercially available from Kraton Polymers LLC as Kraton® MD6459 polymer.
ABCP (Additional Block Copolymer) is a linear block copolymer of styrene (S) and butadiene (B) denoted as (S-B-S) having a monoalkenyl arene content of 38% by weight and a number average molecular weight of about 105,000, commercially available from Kraton Polymers LLC as Kraton® 1155 polymer.
PS (Polystyrene) a polystyrene polymer commercially available from Nova Chemicals as Nova® 2,500.

The following test methods were used in the examples below:
Instrumented impact strength, in inch-pounds, was conducted on a Dynatup® 8250, in accordance with ASTM Standard Test D 3763. Each sample was a 9 to 10 mil thick film. The Dynatup® 8250 comprised a 6.959 lb. hammer; a 500 lb. Piezo tup body and a 22.75 inch gravity drop. The impact velocity was approximately 3,600 in/min.
Haze, in percent, was measured on 9 to 10 mil thick film samples in accordance with ASTM Standard Test Procedure D-1003. A BYK Gardner Haze-gard Plus® was utilized in this test.
Transmission, in percent, was also conducted in accordance with ASTM Standard Test Procedure D-1003 utilizing the same instrumentation.

### EXAMPLES

A plurality of polystyrene-containing films were prepared by blending PS with BCP1. More specifical, eight polymeric compositions of these two components were prepared such that the weight ratios of PS to BCP1 (PS:BCP1) in the eight compositions were 15:85; 25:75; 40:60; 45:55; 50:50; 55:45; 60:40 and 70:30. Of these, Sample Nos. CE1, CE2, CE3 and CE4 (PS:BCP1 weight ratios of 50:50, 55:45, 60:40 and 70:30, respectively) are comparative examples outside of the scope of the present invention. A comparative example that comprises neat BCP1 was also prepared (CE5). The samples are summarized in the Table below as Samples 1-4 and CE1 to CE5, respectively.

Seven three-component polymeric compositions were also prepared. These three-component compositions included the aforementioned PS, BCP1 and ABCP. The PS:BCP1:ABCP weight ratios of the seven compositions were as follows: 80:15:5; 75:20:5; 75:15:10; 70:25:5; 70:20:10; 70:15:15; and 65:30:5. Of these, Sample Nos. CE6, CE7, CE8 and CE9 (PS:BCP1:ABCP weight ratios of 80:15:5, 75:20:5, 70:25:5 and 65:30:5, respectively) are comparative examples outside of the scope of the present invention. The samples are identified in the Table as Samples 5-7 and CE6 to CE9, respectively. For purposes of further comparison, four additional comparative polymeric compositions were also prepared wherein PS was blended solely with ABCP: The weight ratios of PS:ABCP for these examples were 90:10, 85:15; 80:20 and 70:30. These samples are included in the Table as Samples CE10 to CE13, respectively.

All of the aforementioned polymeric compositions were formed into films on a Killion® cast film line. In this cast film line, the extruder zone temperatures ranged between 375° F. to 420° F. The die temperature was 410° F.; the chill roll temperature was 120° F. The chill roll rotated at a rotational speed of 10 rpm; the nip roll rotational speed was 10.1 rpm. The extruder screw speed was 74.9 rpm.

The aforementioned cast film line produced films having thicknesses of between 9 and 10 mils. These resultant films were stored for at least 24 hours at a constant temperature and humidity (23° C., 50% humidity) and then tested to determine their impact properties and optical characteristics. The results of these tests are summarized in the Table below.

TABLE

| | | | | | | Inst. |
|---|---|---|---|---|---|---|
| Sample | PS:BCP1 | PS:BCP1:ABCP | PS:ABCP | | | Impact. |
| No. | Wt. Ratio | Wt. Ratio | Wt. Ratio | Haze, % | Trans, % | in-lb. |
| 1 | 15:85 | | | 1.44 | 92.6 | 9.85 |
| 2 | 25:75 | | | 1.49 | 92.2 | 11.33 |
| 3 | 40:60 | | | 2.13 | 91.8 | 13.7 |
| 4 | 45:55 | | | 3.50 | 91.8 | 13.99 |
| CE1 | 50:50 | | | 3.37 | 91.9 | 5.47 |
| CE2 | 55:45 | | | 3.31 | 91.8 | 2.07 |
| CE3 | 60:40 | | | 2.08 | 92.0 | 0.92 |
| CE4 | 70:30 | | | 2.41 | 91.8 | 0.97 |
| CE6 | | 80:15:5 | | 4.55 | 90.0 | 0.43 |
| CE7 | | 75:20:5 | | 3.98 | 90.5 | 0.51 |
| 5 | | 75:15:10 | | 9 | 88.2 | 0.93 |
| CE8 | | 70:25:5 | | 4.74 | 90.3 | 0.52 |
| 6 | | 70:20:10 | | 7.48 | 89.2 | 1 |
| 7 | | 70:15:15 | | 13.7 | 86.8 | 10.12 |
| CE9 | | 65:30:5 | | 4.59 | 90.8 | 0.61 |
| CE5 | 0:100 | | | 2.53 | 92.5 | 8.61 |
| CE10 | | | 90:10 | 25.8 | 83.6 | 1.97 |
| CE11 | | | 85:15 | 26.4 | 82.5 | 3.17 |
| CE12 | | | 80:20 | 34.9 | 81.5 | 8.67 |
| CE13 | | | 70:30 | 34.6 | 81.9 | 11.00 |

The results of the aforementioned tests, summarized in the Table above, emphasize the improved results achieved with the present invention. Indeed, certain of these results are quite remarkable. For example, for neat BCP1 (Sample No. CE5), the film impact was 8.61 in-lb. It is well known that neat crystal PS is brittle. However, unexpectedly when the brittle PS was blended with BCP1 toughness was improved, not degraded. For example, blending 25% brittle PS with 75% BCP1 increased toughness to 11.33 in-lb (Sample No. 2); blending 45% PS with 55% BCP1 increased toughness to 13.99 in-lb (Sample No. 4). When 50% PS was blended with 50% BCP1, the impact decreased considerably to 5.47 in-lb (Sample No. CE1). When the concentration of PS was increased to 50% or greater, the product was less tough at a ratio of 50:50 and with increasing amounts of PS began to show brittle behavior (see Samples Nos. CE1, CE2, CE3 and CE4). It is surprising that when PS is blended with BCP1 at certain concentrations that toughness improves compared to the neat BCP1 (CE5).

Normally, when using ABCP to modify PS, the blend had higher impact but lower optical properties. As shown in Sample No. CE11, with 80% PS and 20% APCP, the haze of the blend was at 34.9% and the impact was 8.67 in-lb. Using BCP1 to replace part of ABCP, as shown in Sample No. CE6, with 80% PS, 5% ABCP and 15% BCP1, the blend had lower haze and much lower impact strength. The surprising phenomenon is that when PS was at 70%, using BCP1 to replace part of ABCP resulted in better optical properties without sacrificing the impact property. For example, in Sample No. CE13, with 70% PS and 30% ABCP, the haze was 34.6%, and impact was 11 in-lb. when using 15% BCP1 to replace 15% ABCP, as shown in Sample No. 7, the blend had much lower haze, higher transmission, and similar impact properties. Another surprising phenomenon is that BCP1 can behave as a good compatibilizer between PS and ABCP at an optimum concentration. For example, with 85% PS and 15% ABCP (Sample No. CE11), the haze was 26.4% and impact was 3.17 inch. When 15% BCP1 was added in the blend, as shown in Sample No. 7, with 70% PS, 15% ABCP, and 15% BCP1, the blend had both improved impact and optical properties, the blend had impact of 10.13 in-lb, and haze of 13.7%.

The above embodiments and examples are given to illustrate the scope of the present invention. These embodiments and examples will make apparent, to those skilled in the art, other embodiments and examples. Those other embodiments and examples are within the contemplation of the present invention. Therefore, the present invention should be limited only by the appended claims.

What is claimed is:

1. A polymeric composition comprising:
(a) at least one styrene polymer; and
(b) at least one unsaturated block copolymer having a monoalkenyl arene content equal to or greater than 60 weight percent, based on the total weight of the block copolymer, a modulus less than 100,000 psi, and comprising at least one A block and at least one B block, each A block independently selected from mono alkenyl arene polymer blocks and each B block independently selected from polymer blocks having at least one conjugated diene and at least one mono alkenyl arene and having a controlled distribution;
wherein the styrene polymer is present in the polymeric composition in an amount from greater than or equal to 5 weight percent to less than 50 weight percent and the unsaturated block copolymer is present in the polymeric composition in an amount from greater than 50 weight percent to less than or equal to 95 weight percent, each based on the total weight percentage of the polymeric composition.

2. The polymeric composition of claim 1 wherein the styrene polymer is selected from general purpose crystal styrene homopolymers, high heat styrene homopolymers and high flow styrene homopolymers.

3. The polymeric composition of claim 2 wherein each A block of the unsaturated block copolymer comprises styrene and each B block of the unsaturated block copolymer comprises styrene and butadiene.

4. The polymeric composition of claim 3 wherein the monoalkenyl arene content of the block copolymer is from 60 to 85.

5. The polymeric composition of claim 4 wherein the block copolymer has a modulus from about 40,000 to about 90,000.

6. The polymeric composition of claim 5 wherein the unsaturated block copolymer is selected from block copolymers of the structure A-B, A-B-A, (A-B)n, (A-B)n-A, (A-B-A)nX, (A-B)nX and mixtures thereof.

7. The polymeric composition of claim 6 wherein the unsaturated block copolymer has at least two A blocks and at least one B block.

8. The polymeric composition of claim 7 wherein the block copolymer is a coupled block copolymer.

9. A polymeric composition comprising:
(a) at least one styrene polymer;
(b) at least one unsaturated block copolymer having a monoalkenyl arene content equal to or greater than 60 weight percent, based on the total weight of the block copolymer, a modulus less than 100,000 psi, and comprising at least one A block and at least one B block, each A block independently selected from mono alkenyl arene polymer blocks and each B block independently selected from polymer blocks having at least one conjugated diene and at least one mono alkenyl arene and having a controlled distribution; and
(c) at least one additional unsaturated block copolymer having a monoalkenyl arene content from about 25 weight percent to about 50 weight percent, based on the total weight of the block copolymer and comprising at least one C block and at least one D block, each C block independently selected from mono alkenyl arene polymer blocks and each D block independently selected from conjugated diene blocks;
wherein the styrene polymer is present in the polymeric composition in an amount from 60 weight percent to 80 weight percent, the unsaturated block copolymer is present in the polymeric composition in an amount from 20 weight percent to 10 weight percent, and the additional unsaturated block copolymer is present in an amount from 20 weight percent to 10 weight percent, each based on the total weight percentage of the polymeric composition.

10. The polymeric composition of claim 9 wherein the styrene polymer is selected from general purpose crystal styrene homopolymers, high heat styrene homopolymers and high flow styrene homopolymers.

11. The polymeric composition of claim 10 wherein each A block of the unsaturated block copolymer comprises styrene and each B block of the unsaturated block copolymer comprises styrene and butadiene.

12. The polymeric composition of claim 11 wherein the monoalkenyl arene content of the block copolymer comprising at least one A block and at least one B block is from 60 to85.

13. The polymeric composition of claim 12 wherein the block copolymer comprising at least one A block and at least one B block has a modulus from about 40,000 to about 90,000.

14. The polymeric composition of claim 13 wherein the unsaturated block copolymer having a monoalkenyl arene content equal to or greter than 60 weight percent is selected from block copolymers of the structure A-B, A-B-A, (A-B)n, (A-B)n-A, (A-B-A)nX, (A-B)nX and mixtures thereof.

15. The polymeric composition of claim 14 wherein the unsaturated block copolymer has at least two A blocks and at least one B block.

16. The polymeric composition of claim 15 wherein the block copolymer comprising at least one A block and at least one B block is a coupled block copolymer.

17. The polymeric composition of claim 16 wherein each C block of the additional unsaturated block copolymer is styrene and each D block of the additional block copolymer is butadiene.

18. A film having significantly higher impact strength and clarity comprising a polymeric blend of:
(a) at least one styrene polymer; and
(b) at least one unsaturated block copolymer having a monoalkenyl arene content equal to or greater than 60 weight percent, based on the total weight of the block copolymer, a modulus less than 100,000 psi, and comprising at least two A blocks and at least one B block, each A block independently selected from mono alkenyl arene polymer blocks and each B block independently selected from polymer blocks having at least one conjugated diene and at least one mono alkenyl arene and having a controlled distribution;
wherein the styrene polymer is present in the polymeric composition in an amount from greater than or equal to 5 weight percent to less than 50 weight percent and the unsaturated block copolymer is present in the polymeric composition in an amount from greater than 50 weight percent to less than or equal to 95 weight percent, each based on the total weight percentage of the polymeric composition.

19. The film of claim 18 wherein the styrene polymer is selected from general purpose crystal styrene homopolymers, high heat styrene homopolymers and high flow styrene homopolymers.

20. The film of claim 19 wherein each A block of the unsaturated block copolymer comprises styrene and each B block of the unsaturated block copolymer comprises styrene and butadiene.

21. The film of claim 20 wherein the monoalkenyl arene content of the block copolymer is from 60 to 85.

22. The film of claim 21 wherein the block copolymer has a modulus from about 40,000 to about 90,000.

23. The film of claim 22 wherein the unsaturated block copolymer is selected from block copolymers of the structure A-B, A-B-A, (A-B)n, (A-B)n-A, (A-B-A)nX, (A-B)nX and mixtures thereof.

24. The film of claim 23 wherein the unsaturated block copolymer has at least two A blocks and at least one B block.

25. The film of claim 24 wherein the block copolymer is a coupled block copolymer.

26. A film having significantly higher impact strength and clarity comprising a polymeric blend of:
(a) at least one styrene polymer;
(b) at least one unsaturated block copolymer having a monoalkenyl arene content equal to or greater than 60 weight percent, based on the total weight of the block copolymer, a modulus less than 100,000 psi, and comprising at least two A blocks and at least one B block, each A block independently selected from mono alkenyl arene polymer blocks and each B block independently selected from polymer blocks having at least one conjugated diene and at least one mono alkenyl arene and having a controlled distribution; and
(c) at least one additional unsaturated block copolymer having a monoalkenyl arene content from about 25 weight percent to about 50 weight percent, based on the total weight of the block copolymer and comprising at least one C block and at least one D block, each C block independently selected from mono alkenyl arene polymer blocks and each D block independently selected from conjugated diene blocks;
wherein the styrene polymer is present in the polymeric composition in an amount from 60 weight percent to 80 weight percent, the unsaturated block copolymer is present in the polymeric composition in an amount from 20 weight percent to 10 weight percent, and the additional unsaturated block copolymer is present in an amount from 20 weight percent to 10 weight percent, each based on the total weight percentage of the polymeric composition.

27. The film of claim 26 wherein the styrene polymer is selected from general purpose crystal styrene homopolymers, high heat styrene homopolymers and high flow styrene homopolymers.

28. The film of claim 27 wherein each A block of the unsaturated block copolymer comprises styrene and each B block of the unsaturated block copolymer comprises styrene and butadiene.

29. The film of claim 28 wherein the monoalkenyl arene content of the block copolymer comprising at least one A block and at least one B block is from 60 to 85.

30. The film of claim 29 wherein the block copolymer comprising at least one A block and at least one B block has a modulus from about 40,000 to about 90,000.

31. The film of claim 30 wherein the unsaturated block copolymer is selected from block copolymers of the structure A-B, A-B-A, (A-B)n, (A-B)n-A, (A-B-A)nX, (A-B)nX and mixtures thereof.

32. The film of claim 31 wherein the unsaturated block copolymer has at least two A blocks and at least one B block.

33. The film of claim 32 wherein the block copolymer comprising at least one A block and at least one B block is a coupled block copolymer.

34. The film of claim 33 wherein each C block of the additional unsaturated block copolymer is styrene and each D block of the additional block copolymer is butadiene.
